(19) United States
(12) Patent Application Publication
(10) Pub. No.: US 2024/0411018 A1
(43) Pub. Date: Dec. 12, 2024

(54) PROXIMITY AND DISTANCE DETECTION

(71) Applicant: Elliptic Laboratories ASA, Oslo (NO)

(72) Inventors: Espen KLOVNING, Strømmen (NO); Ludvik LIDICKY, Oslo (NO); Tom Øystein KAVLI, Oslo (NO)

(73) Assignee: Elliptic Laboratories ASA, Oslo (NO)

(21) Appl. No.: 18/702,186

(22) PCT Filed: Nov. 3, 2022
(86) PCT No.: PCT/EP2022/080684

§ 371 Date: Apr. 17, 2024

(30) Foreign Application Priority Data
Nov. 5, 2021 (NO) 20211332

(51) Int. Cl. G01S 15/10; G01S 7/52; G01S 7/524

(52) U.S. Cl. CPC G01S 15/102; G01S 7/524; G01S 2007/52007

(57) ABSTRACT

The present invention relates to an electronic device, as well as related method and system. The electronic device including at least one acoustic transducer adapted to transmit and receive acoustic signals in in a known range, wherein the device includes a transmitter unit connected to said at least one transducer for generating an acoustic signal with at least one predetermined characteristic, and a receiving device for receiving a reflected acoustic signal from an object and being connected to an analyzing unit being adapted to calculate the distance to or movement of the reflecting object and the predetermined characteristics of the transmitted signals. The analyzing unit is adapted to, based on the measured distance or movement, adjust the characteristic of the generated acoustic signal.

The present invention is related to electronic devices using acoustic transducers for measuring the proximity or distance to an object, specifically a user of the device, using ultrasound measurements.

More specifically, the present invention is related to electronic devices using acoustic transducers for measuring the proximity or distance to at least one object, the trajectory, angle or velocity of at least one object, detecting human gestures and hand and finger movement using acoustic measurements. In most cases, the user of the device is the object of interest, but it could be other objects too.

Electronic devices with at least one processing element capable of doing signal processing and an audio system that is capable of transmitting and receiving ultrasound using input and output devices (e.g. microphones, speakers, transducers, etc) can be used for a set of different use-cases such as detecting proximity, gestures, hand and finger movements, presence, fall detection, etc of a user, e.g. for automatic sleep mode or conditional activities.

Presence functionality is becoming more prevalent in a lot of electronic devices and in a wide variety of verticals and use-cases. Traditionally, presence devices have been implemented in single-purpose, presence detection devices based on infrared or ultrasound sensors using limited processing if any. More recent solutions, as discussed in WO2017/137755 or WO2021/045628, a unit is employed where it is possible to use already existing sound transducers in the ultrasound range to detect the proximity of a user. NO20191252 describes a solution for detecting proximity of a cover on a device, including a solution for protecting the speaker by limiting the signal amplitude based on speaker response.

Some recent laptops have included human presence detection (HPD) functionality based on at least one time-of-flight (ToF) sensor, e.g. as discussed in U.S. Pat. No. 8,681,585, or at least one radar sensor. HPD functionality can also be implemented by using other sensors including ultrasound presence detection sensors. EP2271134 and US2016025836 disclose methods for analyzing the received acoustic signals. The benefit of an ultrasound-based presence detection sensor compared to some of the other alternatives is reusing existing hardware such as microphones and speakers in the laptop instead of adding costly ToF sensors or radar sensors as discussed in NO20210304. The advent of tiny screen bezels is also making it harder to find space for hardware sensors.

Ultrasonic measurements are known in the field of electronic devices, e.g. in U.S. Pat. No. 10,523,870 (Elliptic), where movement and distance is used to control the content of a screen on the device. Another example is shown in U.S. Pat. No. 10,061,010B2, where time of flight measurements are used to detect the distance to an object. In U.S. Pat. No. 10,006,996B2 a solution is disclosed where echolocation is used to find the distance to an object and also to the surroundings. KR101665786B1 is related to a method for handling the noise from the surroundings.

In addition to improving the solutions discussed above, it is an object of the present invention to provide a solution providing for proximity and human presence monitoring while reducing the power consumption of the ultrasound transducers and related parts. It is also an object to provide a seamless user experience for a user approaching and leaving an electronic device with a reliable operation and presence detection. These objects are obtained as specified in the accompanying claims.

According to the invention a solution is provided where the power consumption may be reduced by adjusting the characteristics of the transmitted signals based on the distance or movement of the signal.

Ultrasound signals are either narrowband (e.g sines, frequency-stepped sines), broadband (e.g. chirps, arbitrary modulation) or a combination of both. These signal types are typically used in different use-cases based on their specific characteristics. A known problem related to devices, especially mobile phones and similar, is the power consumption of the devices. Although relatively efficient, the use of ultrasound is related to a certain power consumption. This may be handled by only using the solution under predefined situations, but under those situations the power consumption may still be too high. Thus, the present invention provides a means for using the most efficient ultrasonic signals depending on the situation. Sampling rate is another key factor for different use-cases. While gesture and presence detection can be done with a sampling rate of 48 KHz and a signal bandwidth in the 1-3 KHz range, detecting multiple users, hand and finger movements, body parts, user posture, breathing patterns, gait etc requires a higher resolution which again mandates a higher sampling rate (i.e. 96 KHz or higher) and a wideband ultrasound signal usually with a bandwidth larger than 10 KHz. Although the signal processing is similar to gesture and presence detection, use-cases based on the detection capabilities using a wideband signal at a higher frequency as described above will require more ultrasound transducers and processing cycles to identify the different echos during the receive processing. These use-cases can benefit from using larger neural networks based on features extracted from the receive processing to identify different objects whether they are moving or not.

In reality, the most relevant signal types are:
1. Sine
2. Narrowband chirp or similar that has a long range but low resolution in distance estimate
3. Wide band chirp or similar that has a higher resolution in distance, but requires higher power to get the same SNR
4. Pulsed signals (narrow or wide band) that saves power but has lower time resolution.

When there is no presence in the vicinity of the device, a pulsed sine signal could be used for lowest possible power consumption.

When presence is detected from a sine signal, the device could start with a narrow band chirp at a low pulse rate to approximately determine distance. As the person moves to closer zones we can increase pulse rate and pulse bandwidth in order to more accurately estimate distance and track movements. In the innermost zone we can have the highest pulse rate and bandwidth in order to detect arms and body movements such as gestures. While using high frequency signals including ultrasonic frequencies it is also in some cases possible to detect turbulence in the air, which may be an indication of a person breathing close to the presence detection device (e.g. laptop), where the characteristics of the received signal may be distinguishing the user from a passive object.

Also, narrowband signals are typically good at detecting movement using doppler-shifts etc while broadband signals can be used to measure distance to moving or non-moving users and objects.

In this context it should also be noted that while the specification here defines the presence detection in the sense of the user being present within a predetermined sone, such as distance from the device or selectable area detectable by the device, the presence detection may also include the possibility for measuring the posture of the person by analyzing the received signal based on signal strength, profile and length of the received signal compared to the transmitted signal, a sequence of received signals may be interpretated as gestures, etc. Voice recognition may be used as a verification of the right user making it possible to ignore other people or objects detected.

In mobile phones and similar devices there are use-cases where using both signal types at the same time or switching between different types of signals is an obvious advantage for a multitude of reasons. The echo of a narrowband signal can be detected with higher sensitivity in a noisy environment since very narrowband filtering can be used to remove noise and improve SNR.

Narrowband signals usually spread further when one or more output devices (e.g. speaker, ultrasound transducers, etc) are powered by devices where power consumption is an issue. Broadband signal does not spread as far with a similar level of power consumption.

The chosen signal type may also depend on other considerations. For example, changing to a narrowband signal from a broadband signal may be beneficial if there is interference in parts or the entire frequency range of the broadband signal due to other transmitting devices in close proximity.

The present invention is thus based on the utilization of these different signal types. The invention will be described below with reference to the accompanying drawings, illustrating the invention by way of examples.

FIG. 1 illustrates a device surrounded by two distance zones.

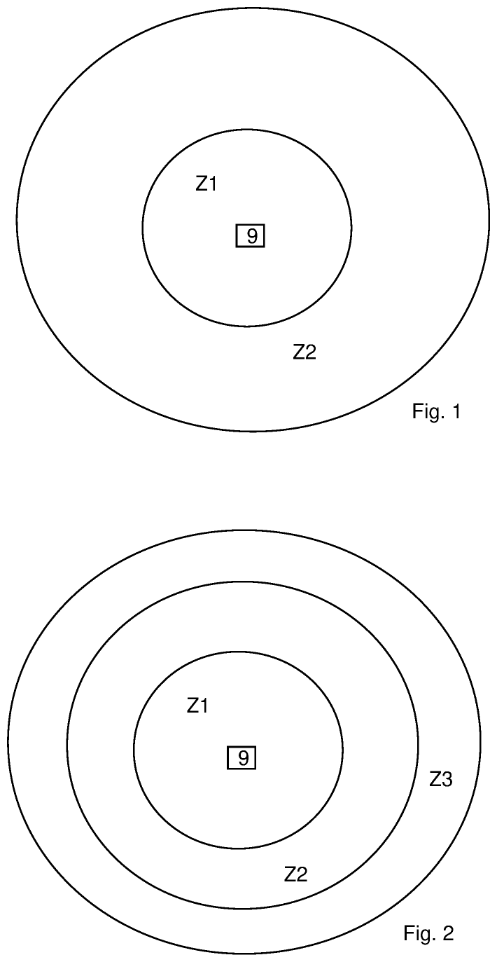

FIG. 2 illustrates a device surrounded by three distance sone.

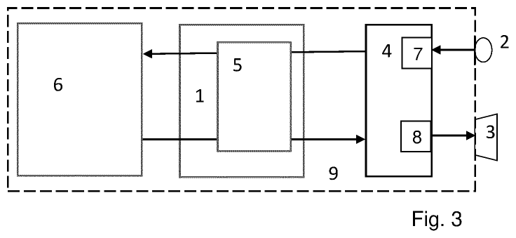

FIG. 3 illustrates an embodiment of the circuitry of the device.

The concept described here is based on two or more detection zones. The presence device 9 will use different signals to detect presence and movement in different zones. In general, the presence detection zones consists of a set of N zones where N=1, 2, 3, . . . , n. The presence detection device will utilize predetermined characteristics of the transmitted signal to tailor the signal output to where the objects to be detected are located. There may be multiple objects in the presence detection zone and the presence detection device may have to use a combination of narrowband and broadband signals. The amplitude of either signal, that is, narrowband or broadband, may be dynamically adjusted based on the current state of the objects identified by the presence detection device to make sure the corresponding signal(s) will reach the zones in question and provide the detection that is required.

In the simplest case, the solution would only have two zones where the presence detection device could switch from transmitting a long-range narrowband signal to a broadband signal with shorter reach when the object(s) are moving from Zone 2 (Z2) to Zone 1 (Z1) and vice versa. Depending on the required power consumption the presence detection device may even continue to transmit the narrowband signal when the object(s) are moving from Zone 2 to Zone 1. This will allow the presence detection to monitor additional moving objects entering Zone 2 from outside the presence detection zone.

As is illustrated in the drawings, zone 1 may be defined as the space where the user may have an active use of the device, e.g being sufficiently close to use keyboard, mouse or other facilities that require some activity of the device. Zone 2 may be in the simple example in FIG. 1 be defined as outside the reach of active use of the device where the device may want to detect if a user moves into the range. In some embodiments, as illustrated in FIG. 2, the zone 2 may allow active use through gestures or remote control, thus maintaining the activity of the device but possibly charging to an alternative use-mode such as ignoring mouse and keyboard but using gesture recognition using acoustic or optical monitoring means. As illustrated in FIG. 3 three zones Z1,Z2,Z3 may also be used defining three threshold distances from the device defining different activities and operation modes of the device 9.

The concept described here is applicable to presence devices (i.e. ultrasound alarm, laptop, smart speaker, TV, etc) capable of performing signal processing in a processing element in the device, which may include neural network processing. The output signal of the presence device is a narrowband ultrasound signal when there is no one inside the detection zone of the presence device. Once at least one moving object (e.g. people, animals, etc) enter the outer perimeter of Zone 2, the presence device will based on echo analysis estimate when the object will reach the Zone 1. Once that happens, the ultrasound output signal of the presence device will change from a narrowband to a broadband signal to estimate the distance to the moving object from the presence device. Once the object is estimated to leave Zone 1, the presence detection device will switch from the broadband signal to the narrowband signal capable of detecting the moving objects in Zone 2.

The scheme discussed above can be handled similarly with a hybrid signal where the presence device transmits both a narrowband and a broadband signal simultaneously, or other types of signal, e.g. changing pulse rates as a function of measured or assumed distance. The drawback of the hybrid solution is the increase in power consumption and processing cycles to transmit both signals simultaneously and process their acoustic echos when received via the ultrasound input device (e.g. microphone, transducer, etc). The amplitude of the narrowband and/or broadband signals may be dynamically reduced as the object(s) are getting closer to the presence detection device in an effort to reduce the power consumption. In addition, it will potentially reduce the headroom for concurrent use-cases playing audio in the presence detection device if output device overflow is to be avoided.

Power consumption is a key factor in for example battery powered presence detection devices that are expected to run for a long time only powered by a built-in, possible replaceable battery. Thus, schemes like the zone-based solution discussed here that are consuming less power are preferred.

The present invention may thus include the use of one zone where human presence is detected, e.g. on a laptop, using the following scheme to increase performance and lower power consumption at the same time, and one zone where the human presence is not detected and then most likely outside the range of the systems first zone.

Human presence detection (HPD) can then be divided into two different phases called Approach mode and Leave mode defined as follows.

Approach mode: The phase where the human presence detection device is locked and waiting for an approaching user. When at least one user has been detected within the defined detection zone which may vary from device to device, the presence detection device will leave the low-power state and enter another state where the user can log in using any available login mechanism including keyboard, face recognition, 2-factor authentication or other biometric solutions.

In the simple case, the second zone may then be defined as outside the reach defined by the presence detection, wherein the device is operated so as to detect the approach of a user.

Leave mode: The phase where the human presence detection device is not locked and keeps track of the user to detect when the user leaves the device detection zone 1 to enable the system to lock the device.

While the user is interacting with the laptop being in the first zone, the presence detection sensor may continue to run in the background to enable it to detect when the last user is leaving the defined detection zone around the device. As long as the user has other activities, such as using keyboard or mouse, the presence detection may be run at a minimum while after a certain inactive period so as to find if the user is still present, e.g. watching a movie on the device, or is leaving the device.

Once this user leaves the detection zone 1, the device should enter a low-power state where the screen may be turned off and the device possibly locked primarily for security reasons requiring the user to log in again. This presence monitoring may as an example be performed according to previously filed Norwegian application No. 20210781 (P6360).

As discussed above, the device will preferably send out an ultrasound signal. These signals may be sent continuously or pulsed depending on use-case and device capabilities or limitations. These signal types are typically used in different use-cases based on their specific characteristics. The predetermined characteristics of the transmitted signal may thus depend on the situation but may include frequency, power, and pulse repetition rate, length and sequence, as well as specified frequency and/or amplitude modulation, but preferably at least one of signal bandwidth, amplitude, pulse repetition rate and pulse length.

The adjusted characteristic may depend on the quality of the received signals and the distance from or movement of the object so as to optimize the transmitted energy and thus reduce the overall power consumption.

As stated above, narrowband signals are typically good at detecting movement using doppler-shifts etc while broadband signals can be used to measure distance to moving or non-moving users and objects. Narrowband signals may be continuous or periodic depending on the required activity. When using a narrowband signal, the signal amplitude should be lower in the approach mode and higher in the leave mode. It is also possible to use a stepped-frequency scheme in which only one narrowband tone at the time is being played. This will enable use a narrow-band filter to boost SNR and potentially thereby lower the signal amplitude

Although a continuous signal allows the presence detection device to keep track of users in its detection zone all the time, the power consumption of such a solution might not be acceptable. As a compromise, the presence detection device may have to change to a pulsed signal to reduce the power consumption of the output device. When using a pulsed broadband signal, the presence device will send out an acoustic signal with a specific, potentially variable length with a fixed or variable pulse rate. A fixed pulse rate is the most common approach but there are situations where it could be beneficial with a variable pulse rate. One example is electronic devices transmitting interfering ultrasound in the same frequency band as the presence detection device with a different signal. In this case, the presence detection device might alter the pulse rate slightly to avoid interference from at least one other transmitting device in its space.

As an alternative, with access (e.g. loopback outgoing audio into ultrasound module, etc) to concurrently playing audio if any on the same output device as the ultrasound signal, the presence detection device could analyze the audio output and potentially temporarily delay an instance of its output signal to reduce possibility of intermodulation or saturation thereby making the pulse rate variable. The receive processing module should preferably be able to deduce the shift in output signal (i.e. samples, time-shift) based on loopback of the audio data immediately before being modulated out on at least one speaker (e.g. echo reference signal) or being explicitly notified about the shift and possibly signal scaling when the output signal was transmitted to make it easier to adjust the timing and expected output signal used by the receive processing.

Based on the comparison between the acoustic signal that was played out and the received signal it is also possible to use an audio playback signal such as playing music, video etc, for presence detection instead of the ultrasound output signal. The playback signal should preferably be played on the presence device itself but it is also possible to use another playback device, e.g smart speaker, close by as the sound source for the presence detection solution. It would require analyzing where the playback device is playing from and use that information to analyze acoustic echos from the user if any to determine if the user is in fact present. This would allow the presence detection device to turn off the ultrasound signal while the audio playback is going on. Once the playback ends or the audio output volume is too low to be used reliably for presence detection, the presence detection device should start transmitting ultrasound again. If the playback resumes the ultrasound signal can be stopped again.

In approach mode, when the device keeps looking for an approaching user, the pulse rate should be adapted to the use case in question. In some use-cases, the system needs to be reactive to detect the approaching user(s) as soon as possible to enable an action to take place almost immediately, e.g. preparing a personal computer for login, sounding an alarm, turning on another interactive, electronic device, etc. Thus, the size of the first zone 1 may be defined by these choices.

In a personal computer, the pulse rate of the presence detection sensor needs to be high enough that the user login can be done without any noticeable delay for the user. It means that the pulse rate could be based on how far away an approaching user will be detected. The further away the user is initially detected during an approach, the lower the pulse rate can be and still enable the presence detection device to detect the user in time. In other presence detection systems, the detection delay is not as important in leave mode and the pulse rate can be reduced accordingly. Still, the pulse rate could be adapted to fit with how far away a leaving user will be detected. Ideally, the pulse rate should be high enough that the leaving user will be detected while leaving the detection zone 1. If there is no activity in the vicinity of the device, the pulse rate can be lowered. As soon as any activity is detected the pulse rate should be increased. On the other hand, the pulse rate can be decreased when the presence is detected in other ways, such as using the computer.

Another example of the value of a variable pulse rate during approach where a user approaching is detected either at the outside or just inside of the detection zone. As the user approaches the presence detection device estimated by the ultrasound processing done by the presence detection sensor, the pulse rate could be increased gradually up to an upper limit aligned with the power consumption requirements of the device or until the signal is practically continuous. This allows the presence detection sensor more information for its ultrasound processing possibly done using machine learning based on neural networks and allows the sensor to track the user better. If the user stops the approach and starts to leave the detection zone again, the pulse rate may be lowered to the standard pulse rate for approach mode without any users nearby.

It is also possible to use a variable signal amplitude for the presence detection. In ultrasound processing it is easier to detect a large object moving around compared to a smaller, more static object. Similarly, the user may or may not use clothing that absorbs ultrasound signal well (e.g. woolen jumper, etc). In both these situations, the presence detection sensor may dynamically change the amplitude of the ultrasound signal as long as it is in line with the power-consumption requirements of the presence detection device and the concurrently playing audio on the same audio output device if any.

The scheme discussed above can be handled similarly with a hybrid signal where the presence device transmits both a narrowband and a broadband signal simultaneously. The drawback of this solution is the increase in power consumption and processing cycles to transmit both signals simultaneously and process their acoustic echos when received in the ultrasound input device (e.g. microphone, transducer, etc).

The presence detection sensor can also be based on echo analysis detect both static objects and the overall spaciousness of the space it is currently active. Based on that information, which can be included in the presence detection analysis, the presence detection device can alter the output signal to be more suitable to the environment, e.g. lower amplitude, higher amplitude, different signal, different pulse rate, etc. Creating an approach profile (e.g. approach path, elapsed approach time, approach timestamp, etc) based on pattern recognition of approaching users is another way the presence detection sensor can provide pieces of information that the presence detection solution can use.

The approach profile can possibly be developed using either a collection of movement patterns or though incremental, on-device ML training. GPS coordinates or network information can be utilized if the presence detection device is mobile and can easily be moved around. Similarly, a leave profile (e.g. leave path, elapsed leave time, leave timestamp, etc) can be created too based on pattern recognition of users leaving the detection zone of the presence detection device. The information can potentially both be added to its current analysis which may include neural networks processing in a suitable processing element and used to adapt the pulse rate for power saving reasons. Actively using an approach profile is probably more suited to presence devices that are located in the same place all the time (e.g. ceiling-mounted devices) but it could be used for device that are used in the same space for a longer period too as long as the approach profile is invalidated or updated once the fact that the device itself is moved is detected through other sensors (e.g. inertia measuring unit (IMU), motion sensors, camera, etc) or through an aging scheme.

As discussed above, the echo profile may also be used to detect the status of the user, for example recognizing from the echos if the user is standing by the computer or sitting, leaning toward the computer or away. The differences may be learned by a machine learning algorithm.

FIG. 3 illustrates three different embodiments of the system according to the invention connected to a host system 6, including speaker 3 and microphone 2 controlled through a codec 4. The audio system will usually run either in an audio DSP 4 in a main system-on-chip (SoC) design or in a separate audio DSP inside a codec 4 or Smart PA 1. If the system runs inside a Codec DSP or Smart PA with both microphone inputs and speaker outputs, the ultrasound module 5 can be enabled as long as the codec and its DSP is powered on. In this case, the system can be a self-contained unit that can be connected to any system 6 capable of powering the codec and supporting the external interface available in the codec (e.g. Soundwire, SPI, HD-Audio, Slimbus, I2S, etc) The power consumption of these may vary. The system may also be configured to compare the signals sent from the from the transmitter unit 8 to the speaker 3 directly with the signals received through the receiver 2 to the microphone e.g. providing a loopback so as to be able to analyze the received signal, e.g. by comparing transmitted and received signals, detecting distance and movements and adjusting the characteristics of the signal based on this in order to reduce the power consumption.

The speaker 2 and/or microphone 3 is constituted by at least one transducer each and may be configured to in a per se known way register the distance to an object or person as well as the direction of movement, angle of movement as well as velocity of the detected object or person.

If the pulse rate is low (e.g. 2 Hz and lower), the audio system 1 and some of its components can possibly be turned off or moved to a low-power state until the next processing cycles starts. This is only feasible if the power cost of turning the components on and off does not dominate the power consumption. The input path needs to be enabled when the output path is enabled or more specifically enabled as long as the acoustic echos caused by the output signal arrive in the input device to be able to process the ultrasound input and analyze the echos of the transmitted output signal. However, the input path may be active at all times to enable the ultrasound processing module to keep track of other transmitting devices close by in case it needs to make changes to avoid interference with these devices.

The complete hardware system could preferably be designed around a scheme where parts if not the entire audio system and its components are turned on and off while the ultrasound use-case is running for power saving reasons. If the audio system cannot be turned on and off due to high cost of turning the system on again, the system can of course enter a state where as much as possible is turned off or moved to an idle state where the power consumption is low.

A variable but deterministic pulse rate can also be used to reduce the effect of reverberation. During transmission, the ultrasound signal generator could insert zero samples before and/or after the pulse itself to make the pulse rate variable.

As long as the ultrasound processing module is aware of the pulse rate changes, the receive processing can take this account and handle the pulse rate changes. With an approach like this, the echos caused by reverberation can be detected and removed using median filters or similar techniques. The scheme could be improved further by changing the pulse every time. One example would be to use alternate between up and down chirps or different frequency band in each pulse. It will make it easier to identify and remove wraparound echos caused by reverberation. Another technique is to continuously adapt the pulse length and pulse rate to the distance of the closest unidentified echo yet to find out if the echo is a wraparound echo or not.

A randomized, variable pulse rate could also be used to handle interference from other transmitting devices using the same scheme. The variable pulse rate could reduce the interference issues by randomly prevent transmitting devices to send pulses at the same time.

Power consumption is a key factor in for example battery powered presence devices that are expected to run for a long time only powered by a built-in, possible replaceable battery. Thus, schemes like the solution discussed here that are consuming less power are preferred.

There are use-cases where using both signal types at the same time or switching between different types of signals is an obvious advantage for a multitude of reasons. The echo of a narrowband signal can be detected with higher sensitivity in a noisy environment since very narrowband filtering can be used to remove noise and improve SNR. Narrowband signals usually spread further when one or more output devices (e.g. speaker, ultrasound transducers, etc) are powered by devices where power consumption is an issue. Broadband signal does not spread as far with a similar level of power consumption.

Similarly, change to a narrowband signal from a broadband signal may be beneficial if there is interference in parts or the entire frequency range of the broadband signal due to other transmitting devices in close proximity.

Another aspect of the invention is related to The choice of frequency range. It is well known that measurements based on ultrasound will increase the accuracy and resolution compared to audible frequencies Thus a detection system based on ultrasound utilizing a set of ultrasound transducers can be used to detect multiple objects close to the device. If an electronic device with at least one ultrasound output transducers sends out a broadband ultrasound signal (e.g. chirp, random modulation, frequency-stepped sines, etc), it can receive the ultrasound signal in at least one ultrasound input transducer and identify multiple objects in the targeted detection area. The different techniques to do this processing is known in the prior art as described in more detail in WO2017/137755, WO2009/122193, WO2009/115799 and WO2021/045628.

The resolution of the identified echos depends on bandwidth and frequency range of the signal. Higher sampling rates supported already by some consumer electronics (e.g. 96 KHz, 192 KHZ, 384 KHz, etc) allows an increased signal bandwidth (e.g. more than 10 KHz) in a frequency range above the audible frequency range. With an increased signal frequency range and signal bandwidth, it is possible to identify multiple users (e.g. objects) and for each of them separate the different body parts such as fingers, hands, arms, head, torso, legs, etc.

In one embodiment of this invention, a laptop could send out a high-frequency, broadband signal to detect user presence. It could also detect user posture and breathing pattern while the user is sitting in front of the laptop whether he/she is interacting with it or not. The echo information could be combined with sensor data (e.g. hinge angle sensor, IMU sensor, light sensor, pressure sensor, ambient light sensor, etc) to provide more accurate information related to the detection. Identifying users peeking over the shoulder of the main laptop user is also possible with the increased resolution described here.

In another embodiment, a presence detection device could send out a high-frequency broadband signal to detect user presence. Since the resolution of the echos will be significantly higher and more details can be extracted, the presence detection device could monitor user movement and fed the data into an incremental, on-device ML-training process to create a continuously updated system such as deep neural network (DNN) that can be used to detect anomalies in user movement and gait.

A main object of the invention is to lower power consumption while the presence detection is running. A higher pulse rate means that the presence detection will be more reactive which is important in the approach phase. At the same time, the user will move towards the device and be detectable even with a lower signal amplitude. Once the user has logged onto the laptop, the system does not have to be as reactive anymore and the pulse rate can possibly be reduced. This will depend on the how still, for example, the user of a laptop is sitting. If the user is moving a lot, the pulse rate can be reduced. However, if the user is very still, the pulse rate may have to be increased to look for subtle movements more often. Since a laptop user in most cases will not move as much, the signal amplitude should be increased to improve the SNR. An alternative approach would be to change even the type of signal used between approach and lock states. During approach mode, the signal should be optimized to detect a user approaching the device. During the leave mode, the signal should be optimized to detect users that are sitting in front on the laptop possibly sitting very still.

In some use-cases (e.g. measuring gestures as well as presence), each transmitting device offering a similar type of use-case using an interchangeable signal does not have to transit the ultrasound signal itself. As long as at least one other device (i.e. master transmitting device) is transmitting the ultrasound signal, any number of other devices can still process the ultrasound signal and provide the expected results. In situations like this, transmitting devices should include a protocol to stop sending the ultrasound signal if there are other devices that transmit the required signal. The protocol should include mechanisms to become the master transmitting device to start sending the ultrasound signal again immediately once the previous master stops transmitting the output signal for any reason.

To summarize the present invention relates to an electronic device including at least one acoustic transducer adapted to transmit and receive acoustic signals in in a known range. The device includes a transmitter unit 8 connected to said at least one transmitting transducer 3 for generating an acoustic signal with at least one predetermined characteristic, and a receiving device 7 connected to a receiving transducer 2 for receiving a reflected acoustic signal from an object and being connected to an analyzing unit 1 being adapted to calculate the distance to and/or movement of the reflecting object based on the characteristics of the transmitted signals. The analyzing unit 1 is configured to, based on the measured distance and/or movement, adjust the characteristics of the generated acoustic signal. Depending on the transducer configuration, such as the number and capabilities of the transducers, the movement may be registered in the direction toward the transducers or, for example using two or more receiving transducers, the direction, angle and velocity of the movement relative to the device.

Preferably the analyzing unit is adapted to detect if the distance is above or below at least one threshold value, wherein the characteristic is chosen from a list of at least two different characteristics depending on the distance being above or below the distance value.

The characteristic may typically include the power of the emitted signal, where the power may be reduced when the distance is below a defined threshold. The chosen adjusted characteristics is based on the known power consumption related to the transmitted and received signals, so as to minimize the power consumption depending on the distance or movements of the object

The characteristics are dynamic within at least one of the zones, adjusting the characteristics depending on the measured or detected activity of the user.

The device may also reduce the power consumption of the transducers, for example by adjusting the signal characteristics, when active use, such as use of keyboard or touchpad, is registered.

The signal characteristics may include at least one of the following: signal bandwidth, amplitude, pulse repetition rate and pulse length.

Preferably the analyzing unit is synchronized with the transmitter unit so as to at any time base said calculations on the timing of the transmitted signals. The transmitted signals may be in the audible range or may be in the near ultrasound range, where the analyzing unit may base the detection on phase difference and/or time difference between transmission or reception between the transmitted and received signal. When the transmitted characteristic signal is in the ultrasound and audio range, the ultrasound signals are transmitted when the level of the audio sound is below a predetermined limit. If the device is transmitting sounds from a know source, such as streaming services playing known music, or based on previously registered sounds recognized through machine learning techniques, predicting the audio sound level to maximize the chance of transmitting once own signal without triggering speaker protection algorithms or distorting the signal. It is also possible to base the prediction on real-time measurements and short time predictions based on the pattern of the recently transmitted audio signal.

According to an alternate embodiment, the invention relates to a system including at least one acoustic transducer adapted to transmit and receive acoustic signals in the ultrasound range. The system includes a transmitter unit connected to said at least one transducer for generating an acoustic signal with at least one predetermined characteristic, and a receiving device for receiving a reflected acoustic signal from an object and being connected to an analyzing unit being adapted to calculate the distance to or movement of the reflecting object and the predetermined characteristics of the transmitted signals. The analyzing unit is adapted to, based on the measured distance or movement, adjust the characteristic of the generated acoustic signal. The transmitter unit and receiver units may then be positioned in separate devices. As an example, the transmitter may be a speaker sending a known signal, such as a known piece of music or signal, the signal being recognized, e.g. using a database, in the analyzing unit and using two or more receiving transducers the presence of a person or object in the room may be found by analyzing the difference between the received signals, as a change in a person position may be detected by a change in the received signals.

The analyzing unit in the system may be configured to communicate with the transmitter and receiver so as to base the analysis on the comparison of the transmitted and received signals.

The analyzing unit is configured to receive signals from other devices in the environment, such as a wearable unit configured to measure the orientation of a person, eg. for fall detection, during a detected movement or change in distance.

The present invention also relates to a method for monitoring user proximity of a device including a transmitter and a receiver being configured for transmitting and receiving signals in the ultrasound range. The method including the step of, at the detection of an object, adjusting the transmitted signal characteristics depending on the distance or movements of the object, so as to reduce the power consumption depending on the movement and distance.

1. An electronic device comprising at least one acoustic transducer adapted to transmit and receive acoustic signals in a predetermined frequency range, wherein the device includes a transmitter unit connected to the at least one transducer for generating an acoustic signal with at least one predetermined characteristic, and a receiving device for receiving a reflected acoustic signal from an object and being connected to an analyzing unit being adapted to calculate the distance to or movement of the reflecting object and the predetermined characteristics of the transmitted signals, wherein the analyzing unit is adapted to, based on the measured distance or movement, adjust the characteristic of the generated acoustic signal.

2. The electronic device according to claim 1, wherein the analyzing unit is adapted to detect if the distance is above or below at least one threshold value, wherein the characteristic is chosen from a list of at least two different characteristics depending on the distance being in a distance zone above or a distance zone below the distance value.

3. The electronic device according to claim 1, wherein the characteristic includes the power of the emitted signal.

4. The electronic device according to claim 2, wherein the characteristics are dynamic within at least one of the distance zones, adjusting the characteristics to the activity of the user.

5. The electronic device according to claim 4, wherein the power consumption of the transducers is reduced when active use is registered by the device.

6. The electronic device according to claim 1, wherein the predetermined characteristics include at least one of the following: signal bandwidth, amplitude, pulse repetition rate, and pulse length.

7. The electronic device according to claim 1, wherein the analyzing unit is synchronized with the transmitter unit so as to at any time base the calculations on the transmitted signals.

8. The electronic device according to claim 1, wherein the transmitter unit is configured to transmit signals both in the ultrasound and audio range, wherein the transmitted ultrasound signals are transmitted when the level of the audio sound is below a predetermined limit.

9. The electronic device according to claim 1, wherein the chosen adjusted characteristics is based on the known power consumption related to the transmitted and received signals, so as to minimize the power consumption depending on the distance or movements of the object.

10. A system comprising at least one acoustic transducer adapted to transmit and receive acoustic signals in the ultrasound range, wherein the system includes a transmitter unit connected to the at least one transducer for generating an acoustic signal with at least one predetermined characteristic, and a receiving device for receiving a reflected acoustic signal from an object and being connected to an analyzing unit being adapted to calculate the distance to or movement of the reflecting object and the predetermined characteristics of the transmitted signals, wherein the analyzing unit is adapted to, based on the measured distance or movement, adjust the characteristic of the generated acoustic signal, wherein the transmitter unit and receiver units are positioned in separate devices.

11. The system according to claim 10, wherein the analyzing unit is configured to communicate with the transmitter and receiver so as to base the analysis on the comparison of the transmitted and received signals.

12. The system according to claim 10, wherein the analyzing unit is configured to receive signals from other devices in the environment.

13. A method for monitoring user proximity of a device comprising a transmitter and a receiver being configured for transmitting and receiving signals in the ultrasound range, the method comprising the step of, at the detection of an object, adjusting the transmitted signal characteristics depending on the distance or movements of the object, so as to reduce the power consumption depending on the movement and distance.

14. The electronic device according to claim 5, wherein the active use is use of keyboard or touchpad or touchscreen.

15. The system according to claim 12, wherein the other devices comprise a wearable unit.

16. The system according to claim 15, wherein the other devices are configured to measure the orientation of a person during a detected movement or change in distance.

17. The system according to claim 16, wherein the orientation of a person is for fall detection.
